(19) United States
(12) Patent Application Publication
(10) Pub. No.: US 2018/0308185 A1
(43) Pub. Date: Oct. 25, 2018

(54) SYSTEM AND METHOD FOR CHARGING AN ELECTRIC VEHICLE

(71) Applicant: MASTERCARD ASIA/PACIFIC PTE. LTD., Singapore (SG)

(72) Inventors: JIE ZHANG, Singapore (SG); XIJING WANG, Singapore (SG); JIAMING LI, Singapore (SG)

(21) Appl. No.: 15/948,502

(22) Filed: Apr. 9, 2018

(30) Foreign Application Priority Data
Apr. 25, 2017 (SG) 10201703379Y

(51) Int. Cl. G06Q 50/06; G06Q 20/12; G06Q 20/18

(52) U.S. Cl. CPC G06Q 50/06; G06Q 20/18; G06Q 20/127

(57) ABSTRACT

There is provided a system and method for charging an electric vehicle. The method enables a payment convenience for the user seeking to charge an electric vehicle. Whenever the user device pairs with the charging station, and subsequent to electrical coupling between the electric vehicle and the charging station, the user need not initiate steps to select a payment option and ensure that payment is made to charge the electric vehicle, regardless of whether or not the user device has continuous network connectivity.

### BACKGROUND OF THE INVENTION

The present invention relates to a system and method for charging an electric vehicle.

### DESCRIPTION OF THE PRIOR ART

Electric vehicles are becoming more common than ever before. However, the infrastructure which is currently in place for vehicles that are fuelled by fossil fuels is not able to adequately support the increasing number of electric vehicles. For example, there are insufficient numbers of charging points for charging the electric vehicles, and furthermore, where payment is facilitated using mobile devices of users, there may be issues whenever the mobile devices lose data connectivity before/during payment.

Moreover, it is difficult to bolster the infrastructure for electric vehicles whilst fossil fuel vehicles are the substantial majority of vehicles currently plying the roads.

It is generally desirable to improve consumer experiences when making payment subsequent to charging the electric vehicle, and to enhance the infrastructure for charging electric vehicles.

### SUMMARY OF THE PRESENT INVENTION

In a first aspect, there is provided a system for charging an electric vehicle. The system including one or more electronic processing devices configured to:

pair, to a user device, a charging station;

provide, to the user device, a service token, the service token being indicative of a selected payment option from one or more pre-selected payment options;

transmit, to the charging station, upon electrically coupling the electric vehicle to the charging station, the service token;

use, at the charging station, the service token to control the charging station to thereby provide an amount of power to the electric vehicle at least partially in accordance with the selected payment option;

provide, to the user device, a completion token after providing the power to the electric vehicle at least partially in accordance with the selected payment option;

provide, to a payment system, the completion token, the completion token including a payment quantum in accordance with the selected payment option; and

receive, from the payment system, a receipt token in response to successful payment.

In a second aspect, there is provided a method for charging an electric vehicle. The method includes, in one or more electronic processing devices:

pairing, to a user device, a charging station;

providing, to the user device, a service token, the service token being indicative of the selected payment option from one or more pre-selected payment options;

transmitting, to the charging station, the service token;

using, at the charging station, the service token to control the charging station to thereby provide an amount of power to the electric vehicle at least partially in accordance with the selected payment option;

providing, to the user device, a completion token after providing the power to the electric vehicle at least partially in accordance with the selected payment option;

providing, to a payment system, the completion token, the completion token including a payment quantum in accordance with the selected payment option; and

receiving, from the payment system, a receipt token in response to successful payment.

In a third aspect, there is provided a user device for charging an electric vehicle. The user device includes one or more electronic processing devices configured to:

pair with a charging station;

receive a service token, the service token being indicative of a selected payment option from one or more pre-selected payment options;

transmit, to the charging station, the service token;

receive a completion token after providing the power to the electric vehicle at least partially in accordance with the selected payment option;

provide, to a payment system, the completion token, the completion token including a payment quantum in accordance with the selected payment option; and

receive, from the payment system, a receipt token in response to successful payment.

In a fourth aspect, there is also provided a non-transitory computer readable storage medium embodying thereon a program of computer readable instructions which, when executed by one or more processors of a user device in communication with a charging station, cause the user device to perform a method for charging an electric vehicle. The method is embodied in the steps of:

pairing with a charging station;

receiving a service token, the service token being indicative of a selected payment option;

transmitting, to the charging station, the service token;

receiving a completion token after providing the power to the electric vehicle at least partially in accordance with the selected payment option;

providing, to a payment system, the completion token, the completion token including a payment quantum in accordance with the selected payment option; and

receiving, from the payment system, a receipt token in response to successful payment.

There is also provided a charging station for charging an electric vehicle. The charging station includes one or more electronic processing devices configured to:

pair to a user device;

receive, from the user device, the service token;

use the service token to control the charging station to thereby provide an amount of power to the electric vehicle at least partially in accordance with a selected payment option; and

provide, to the user device, a completion token after providing the power to the electric vehicle at least partially in accordance with the selected payment option, the completion token including a payment quantum in accordance with the selected payment option.

Finally, there is provided a non-transitory computer readable storage medium embodying thereon a program of computer readable instructions which, when executed by one or more processors of a charging station in communication with a user device, cause the charging station to perform a method for charging an electric vehicle. The method is embodied in the steps of:

pairing to a user device;

receiving, from the user device, the service token;

using the service token to control the charging station to thereby provide an amount of power to the electric vehicle at least partially in accordance with a selected payment option; and

providing, to the user device, a completion token after providing the power to the electric vehicle at least partially in accordance with the selected payment option, the completion token including a payment quantum in accordance with the selected payment option.

It will be appreciated that the broad forms of the invention and their respective features can be used in conjunction, interchangeably and/or independently, and reference to separate broad forms in not intended to be limiting.

### BRIEF DESCRIPTION OF THE DRAWINGS

A non-limiting example of the present invention will now be described with reference to the accompanying drawings, in which: —

FIG. 1 is a flow chart of an example of a method of charging an electric vehicle;

FIG. 2 is a schematic diagram of an example of a system for charging an electric vehicle;

FIG. 3 is a schematic diagram showing components of an example user device of the system shown in FIG. 2;

FIG. 4 is a schematic diagram showing components of an example payment processing device of the system shown in FIG. 2;

FIGS. 5A to 5D is a flowchart of a specific example of a method of charging an electric vehicle;

FIG. 6 is an example of a merchant setup of a charging station that is controllable to provided electrical power to charge an electric vehicle.

### DETAILED DESCRIPTION

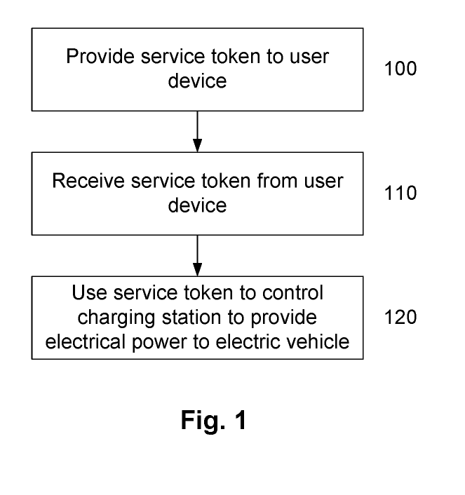

An example of a method of charging an electric vehicle will now be described with reference to FIG. 1.

For the purpose of illustration, it is assumed that the method is performed at least in part using one or more electronic processing devices such as a suitably programmed microcontroller forming part of a user device capable of controlling a charging station and in communication with one or more merchant devices, such as mobile phones, portable computers, tablet computers, or the like. The user device can be integrated with the electric vehicle, for example, when docked/paired with the electric vehicle, as part of the in-car entertainment/navigation system and so forth. The user and merchant devices are also typically in communication with a payment system which may comprise any suitable computer system such as a server that is capable of processing payments made by the user and which may include a number of processing devices associated with each of an issuer, acquirer, card network and payment gateway, or alternatively, the payment processing system may include any one or more of these entities and this will be discussed further below.

The term charging station is intended to cover any electrical device that acts as a conduit for power either from a mains supply, a power generating farm, and so forth. The charging station will typically include one or more electronic processing devices such as a suitably programmed microcontroller, such that the charging station can be configurable to provide power to the electric vehicle on demand.

In this example, at step 100 the one or more electronic processing devices provide a service token to a user device, the service token being indicative of one or more pre-selected payment options associated with providing power to the electric vehicle. The payment options associated with a particular appliance will typically have been pre-selected by a merchant who may supply power to the charging station and/or the charging station. The payment options can include, for example, a time-based power charging option, a power-level based charging option, a cost-based power charging option and the like. The payment option can also be, for example, one-off, for multiple instances, and so forth. The payment option for multiple instances can be for a pre-defined period of time, for example, a few weeks, a few months, a year, and so forth. Such payment options for multiple instances for a pre-defined period of time can be referred to as subscription options.

For example, a user may select a time-based power charging option to ensure that the electric vehicle is able to traverse across a particular mileage, a user may select to charge a power source of the electric vehicle to a percentage of full capacity of the power source, a user may select a time-based power charging subscription option and so forth. Other than the one-off payment option, it should be appreciated that the selection can be set as a default option such that the user need not repeatedly make the selection whenever the user visits the charging station to charge the electric vehicle.

Typically, the one or more electronic processing devices user communicate with the user device to provide the service token via a wireless communications protocol such as Bluetooth, Zigbee, Wi-fi and the like. In one example, the charging station includes a wireless transceiver such as a Bluetooth™ Low Energy (BLE) module.

Having received the service token, the user device is typically responsive to provide the service token to the charging station via a wireless communications protocol. The charging station is able to interpret the service token to determine the selected payment option associated with the service token for the charging station.

The user device receives from a payment system an indication of the payment options associated with the service token. For example, the payment system may cause a user interface such as webpage to be displayed on the user device which provides a representation of the payment options (such as $1.00 for 3 minutes, $2.00 for 6 minutes, $10.00 for 50% battery capacity, $15.00 for 75% battery capacity and so forth.). The user then selects a desired payment option for example by clicking on a button indicative of the payment option.

At step 110, upon electrically coupling the electric vehicle to the charging station, the one or more electronic processing devices then receive the service token from the user device. In this regard, the same wireless communication protocol previously described is used by the user device to send the service token to the charging station.

At step 120, the one or more electronic processing devices then use the service token to control the charging station to thereby provide electrical power to the electric vehicle in accordance with the payment option selected by the user. In this regard, the service token will be indicative of the payment option selected by the user and the charging station will be able to interpret the service token to control the charging station in accordance with the selected payment option as will be described in further detail below.

The above described method and associated apparatus provide a number of advantages.

Firstly, the method enables a payment convenience for the user seeking to charge an electric vehicle. As mentioned earlier, other than the one-off payment option, the user need not repeatedly select a payment option whenever the electric vehicle needs to be charged. In this regard, whenever the user device pairs with the charging station, and subsequent to electrical coupling between the electric vehicle and the charging station, the user need not initiate steps to select a payment option and ensure that payment is made to charge the electric vehicle, regardless of whether or not the user device has continuous network connectivity.

Furthermore, charging stations which can be used by a user with an appropriate user device can be readily distributed, basically to any location where there is access to a power source, and this is advantageous in creating infrastructure for electric vehicles without a need for substantial outlay by governments/state authorities. Consequently, improved infrastructure leads to more electric vehicles on the road and less pollution from fossil-fueled vehicles.

In addition, the charging stations also provide their owners/renters with an opportunity to generate a revenue stream from allowing third parties to freely use their charging stations, and this is also advantageous.

A number of further features will now be described.

As previously mentioned the one or more payment options may be associated with various parameters. In one example, the payment option is associated with providing power to the electric vehicle for a pre-determined amount of time. In this example the user pays to charge the electric vehicle for a certain duration of time, typically defined in minutes or hours of usage (e.g. $1.00 to charge the electric vehicle for 5 minutes, $2.00 to charge the electric vehicle for 10 minutes and so forth). In another example, the payment option is associated with providing a pre-determined cost of electrical power to charge the electric vehicle (e.g. to charge $3.00 worth of power, to charge $5.00 worth of power and so forth). In yet a further example, the payment options are associated with providing an amount of power to the appliance in accordance with a proportion of a capacity of the battery of the electric vehicle (e.g. to charge 30% of the capacity of the battery, to charge 80% of the capacity of the battery and so forth). It should be appreciated that the state of charge may be monitored directly using requisite readers/meters or inferred based on a different parameter such as current drawn by the battery for example.

Furthermore, the payment option can be for multiple instances over a pre-defined period of time, for example, a few weeks, a few months, a year, and so forth. For example, the user can choose to pay to charge the electric vehicle for a certain duration of time for multiple instances over a period of a month. Such payment options for multiple instances for a pre-defined period of time can be referred to as subscription options.

A number of ways of controlling the charging station to provide electrical power to an electric vehicle are contemplated. In one example, upon electrically coupling the charging station to the electric vehicle, the charging station toggles a switch to provide electrical power to the electric vehicle and starts a timer. The timer is used to determine an elapsed charging time of the electric vehicle. The charging station then toggles the switch to cut off the power supply once the charging station determines that the elapsed time meets a pre-determined amount of time indicative of a purchased duration of electrical power supply to charge the electric vehicle.

In a further example, upon electrically coupling the charging station to the electric vehicle, the charging station toggles a switch to provide electrical power to the electric vehicle and starts a reader/meter to monitor an electrical current drawn by the electric vehicle. The reader/meter is used to determine an amount of electric power drawn by the electric vehicle. The charging station then toggles the switch to cut off the power supply once the charging station determines that the drawn electric power meets a pre-determined amount of power indicative of a purchased amount of electrical power supply to charge the electric vehicle.

In another example, upon electrically coupling the charging station to the electric vehicle, the charging station toggles a switch to provide electrical power to the electric vehicle and starts a reader/meter to monitor a level of charge for the battery of the electric vehicle. The charging station then toggles the switch to cut off the power supply once the charging station determines that the drawn electric power meets a pre-determined amount of power indicative of a purchased amount of electrical power supply to charge the electric vehicle.

Typically, before the charging station is ready to be used by a user, it is set up by a merchant in order to provide at least one of the pre-selected payment options. In this regard, the one or more electronic processing devices typically communicate with a merchant device via a wireless communications protocol in order to pre-configure the charging station prior to use by the user. The charging station may communicate with the merchant device via any of the wireless communications protocols previously discussed that may be used to communicate with the user device.

An example of a merchant configuration process shall now be described. In this example, the one or more electronic processing devices firstly generate an initialization token. The initialization token is generated based on a device identifier such as a unique device key assigned to the charging station by the manufacturer. The initialization token is provided to the merchant device in order to configure the charging station with one or more merchant selected payment options. The merchant device is responsive to the initialization token to register the initialization token with the one or more payment options associated with providing electrical power (as described earlier) to the electric vehicle. In one example, this step may be performed using a merchant application executing on the merchant device or via any other suitable interface that allows the merchant to associate payment options with the initialization token.

The merchant device then provides the registered initialization token to a payment system, the payment system responsive to process payment as will be described in further detail below. The merchant device receives provisioning data from the payment system and in turn sends the provisioning data to the charging station. The charging station receives the provisioning data and stores it in a data store forming part of the charging station. The provisioning data is used by the charging station to configure the charging station, so that the processing device can at least partially control the charging station in accordance with the payment option selected by the user.

As previously mentioned, the initialization token is generated using a device identifier associated with the charging station. The device identifier is typically stored in at least one of a local data store and a remote data store (for example associated with the payment system). The local data store typically forms part of the charging station. The remote data store is remote to the charging station and may be in communication with the one or more electronic processing devices via a communications network.

The provisioning data for use in controlling the charging station typically includes at least one of a merchant identifier associated with the merchant, a device identifier associated with the charging station, an indication of the payment options provided by the merchant associated with providing electrical power to the electric vehicle, and instructions for use in controlling the electric vehicle in accordance with the payment options. The provisioning data therefore comprises software and/or firmware that is permanently programmed into the read-only memory of the charging station in order to control the charging station in accordance with the payment options provided by the merchant.

In one example, the one or more electronic processing devices validate the provisioning data prior to storage in the data store. For example, the validation process may include determining that the device key associated with the provisioning data matches the device key of the charging station to which the provisioning data has been sent. This can be achieved in any suitable manner, such as through encryption of the provisioning data using the device identifier, in a manner similar to that described above with respect to the payment token. Furthermore, the validation process may check whether a valid merchant identifier has been provided to ensure that payment for use of the charging station are routed to the appropriate merchant.

It is to be appreciated that the above described method is performed by one or more electronic processing devices forming part of the charging station. The charging station further includes a wireless transceiver module where the one or more electronic processing devices communicate with the user device (and the merchant device) via the wireless transceiver module. In a specific form, the wireless transceiver module is a Bluetooth™ Low Energy (BLE) transceiver module, although it need not be limited to such and could include any suitable wireless transceiver. The charging station may further include a local data store as previously described for storing the provisioning data, device identifier etc.

The above components of the charging station are typically housed within a housing that additionally includes a plug for first releasable coupling to an electrical power supply, and a second releasable coupling for providing an electrical coupling with the electric vehicle. Alternatively, the charging station may include a housing configured for securement to a fixed structure whilst coupled to an electrical power supply. In either case, the charging station is capable of providing an interface between an electrical power supply and an electric vehicle. Whilst typically the power supply will be a mains electricity supply, in some examples the power supply may from a battery or other form of energy storage.

In examples where the charging station monitors current drawn by the electric vehicle in order to control the charging station, the charging station will also include a charge sensor for monitoring a level of charge provided by the charging station or level of charge at a battery of the electric vehicle.

In examples where the payment option is based on a pre-determined time of use of the charging station, there may further include a timer used by the one or more electronic processing devices to determine an elapsed time indicative of at least one of a time period since the charging station initiated charging of the electric vehicle.

In one example, a user application is provided on the user device for controlling the charging station to selectively provide power to the electric vehicle. The user device typically includes one or more electronic processing devices to receive a service token from a merchant device, the service token being indicative of one or more pre-selected payment options associated with providing power to the electric vehicle. The user device then provides the service token to the charging station, the charging station being responsive to the service token to control to thereby provide electrical power to the electric vehicle at least partially in accordance with the payment option selected by the user, upon an electrical coupling between the electric vehicle and the charging station.

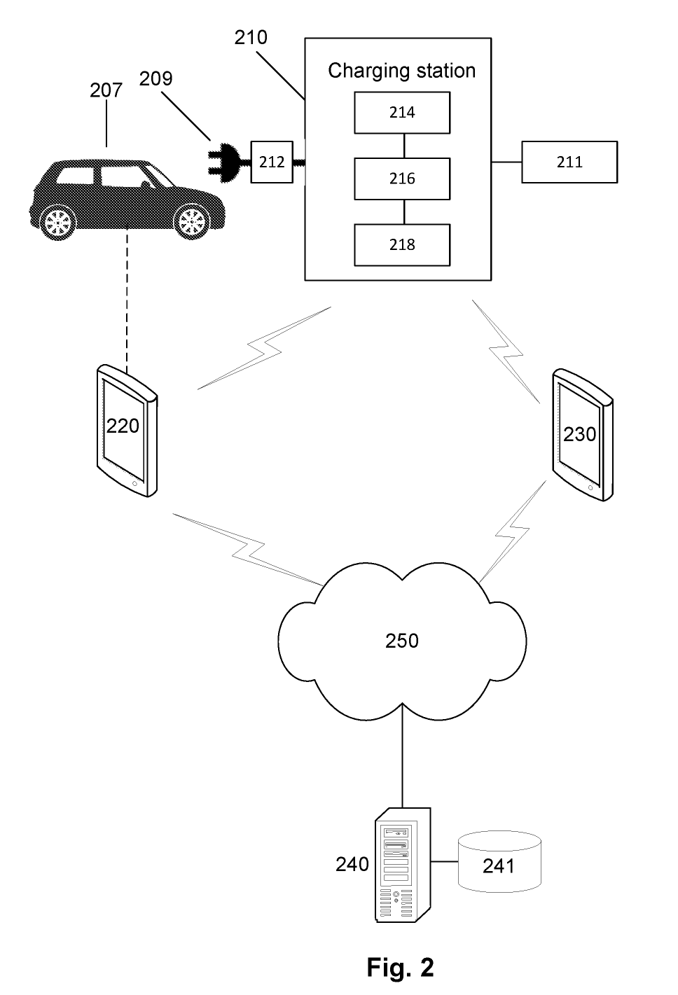

An example of a system for charging an electric vehicle will now be described with reference to FIG. 2.

In this example, the system 200 includes a charging station 210 coupled to a power supply 211 and includes a processing device 214 in communication with a wireless transceiver 216 and a data store 218. The charging station 210 also includes a detachable coupler 209 for electrically coupling the charging station 210 to an electric vehicle 207, and a switch 212 to allow current to flow to the electric vehicle 207. The charging station 210 is further in communication with one or more user devices 220 optionally running a payment application and one or more merchant devices 230 optionally running a merchant application. The user and merchant devices 220, 230 are in communication with a payment system 240 via a communications network 250. The payment system 240 may be in communication with a database 241.

The communications network 250 can be of any appropriate form, such as the Internet and/or a number of local area networks (LANs). It will be appreciated that the configuration shown in FIG. 2 is for the purpose of example only, and in practice the user devices 220, merchant devices 230, charging station 210 and payment system 240 can communicate via any appropriate mechanism, such as via wired or wireless connections, including, but not limited to mobile networks, private networks, such as an 802.11 network, the Internet, LANs, WANs, or the like, as well as via direct or point-to-point connections, such as Bluetooth, or the like. Typically, the one or more user and merchant devices 220, 230 communicate with the charging station 210 via a wireless communication protocol such as Bluetooth, Wi-Fi Zigbee, or through Near Field Communication (NFC) but not limited to such. The user and merchant devices 220, 230 may typically communicate with the payment system 240 over a mobile network or via the Internet.

### User Device 220 and Merchant Device 230

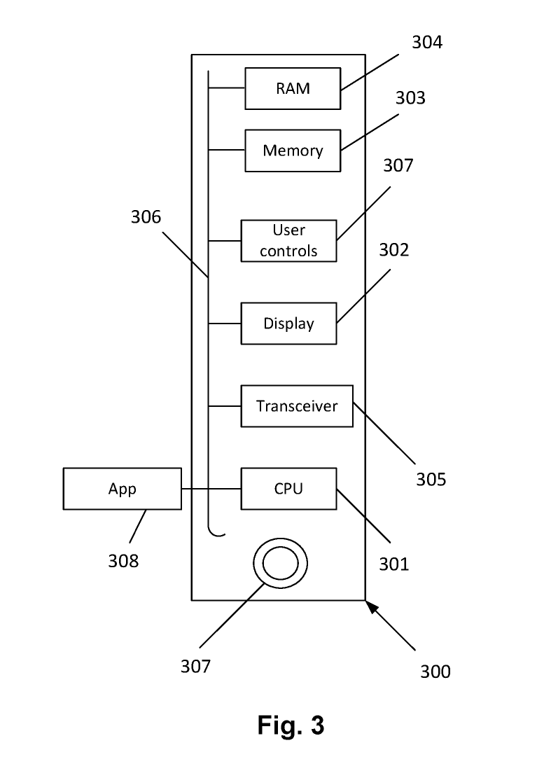

The user device 220 and merchant device 230 of any of the examples herein may be a handheld computer device such as a smart phone or a PDA such as one manufactured by Apple™, LG™, HTC™, Research In Motion™, or Motorola™. The user device 220 or merchant device 230 may include a mobile computer such as a tablet computer or a wearable mobile processing device such as a smart watch. In addition, the user device 220 can also be integrated with the electric vehicle 207, for example, when docked/paired with the electric vehicle 207, as part of the in-car entertainment system or in-car navigation system. An exemplary embodiment of a user/merchant device 300 is shown in FIG. 3. As shown, the device 300 includes the following components in electronic communication via a bus 306:

1. a display 302;

2. non-volatile memory 303;

3. random access memory (“RAM”) 304;

4. N processing components 301;

5. a transceiver component 305 that includes N transceivers; and

6. user controls 307.

Although the components depicted in FIG. 3 represent physical components, FIG. 3 is not intended to be a hardware diagram; thus many of the components depicted in FIG. 3 may be realized by common constructs or distributed among additional physical components. Moreover, it is certainly contemplated that other existing and yet-to-be developed physical components and architectures may be utilized to implement the functional components described with reference to FIG. 3.

The display 302 generally operates to provide a presentation of content to a user, and may be realized by any of a variety of displays (e.g., CRT, LCD, HDMI, micro-projector and OLED displays). And in general, the non-volatile memory 303 functions to store (e.g., persistently store) data and executable code including code that is associated with the functional components of a browser component and applications, and in one example, a user application 308 executing on the user device 220 and a merchant application executing on the merchant device 230. In some embodiments, for example, the non-volatile memory 303 includes bootloader code, modem software, operating system code, file system code, and code to facilitate the implementation of one or more portions of the user application 308 as well as other components well known to those of ordinary skill in the art that are not depicted for simplicity.

In many implementations, the non-volatile memory 303 is realized by flash memory (e.g., NAND or ONENAND memory), but it is certainly contemplated that other memory types may be utilized as well. Although it may be possible to execute the code from the non-volatile memory 303, the executable code in the non-volatile memory 303 is typically loaded into RAM 304 and executed by one or more of the N processing components 301.

The N processing components 301 in connection with RAM 304 generally operate to execute the instructions stored in non-volatile memory 303 to effectuate the functional components. As one of ordinarily skill in the art will appreciate, the N processing components 301 may include a video processor, modem processor, DSP, graphics processing unit (GPU), and other processing components.

The transceiver component 305 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

### Charging Station 210

A suitable charging station 210 for use in the system for charging an electric vehicle described in anyone of the above examples is shown in FIG. 2.

In this example, the charging station 210 includes at least one microprocessor 214, a memory 218, an optional input/output device (not shown), such as a display, keyboard, touchscreen and the like, and a communications interface 216, interconnected via a bus. In this example the communications interface 216 can be utilised by the charging station 210 when communicating with peripheral devices, such as the user and merchant devices 220, 230 Although only a single interface 216 is shown, this is for the purpose of example only, and in practice multiple interfaces using various methods (e.g. Ethernet, serial, USB, wireless, Bluetooth™ Low Energy (BLE), Near Field Communication (NFC), or the like) may be provided.

In use, the microprocessor 214 executes instructions in the form of applications software stored in the memory 218 to allow communication with the user device 220, for example to provide and receive a service token therefrom, and the merchant device 240, for example to provide the initialization token and receive the provisioning data. The applications software may include one or more software modules, and may be executed in a suitable execution environment, such as an operating system environment, or the like.

Accordingly, it will be appreciated that the charging station 210 may include any suitable processing system, such as any electronic processing device, including a microprocessor, microchip processor, logic gate configuration, firmware optionally associated with implementing logic such as an FPGA (Field Programmable Gate Array), or any other electronic device, system or arrangement. Thus, in one example, the charging station 210 is a standard processing system such as an Intel Architecture based processing system, which executes software applications stored on non-volatile (e.g., hard disk) storage, although this is not essential.

The charging station 210 may further include a charge sensor to monitor a level of charge provided by the charging station 210 to the electric vehicle, a timer to calculate an elapsed time that power has been provided to the electric vehicle, a switch 212 to allow current to flow to the electric vehicle 207 and a housing having a detachable coupler 209 for electrically coupling the charging station 210 to the electric vehicle.

### Payment System 240

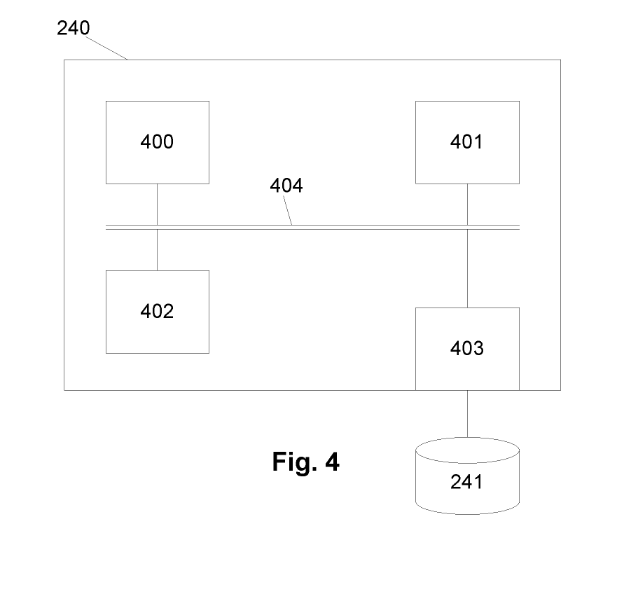

A suitable payment system 240 for use in the system described in anyone of the above examples is shown in FIG. 4.

In this example, the payment system 240 is a server that includes at least one microprocessor 400, a memory 401, an optional input/output device 402, such as a display, keyboard, touchscreen and the like, and an external interface 403, interconnected via a bus 404 as shown. In this example the external interface 403 can be utilised for connecting the payment server 410 to peripheral devices, such as user and merchant devices 220, 230, the communication networks 250, databases 241, other storage devices, or the like. Although a single external interface 403 is shown, this is for the purpose of example only, and in practice multiple interfaces using various methods (e.g. Ethernet, serial, USB, wireless or the like) may be provided.

In use, the microprocessor 400 executes instructions in the form of applications software stored in the memory 401 to allow communication with the user device 220, for example to receive a service token and to provide payment options, and the merchant device 230, for example to receive the registered initialization token and to provide provisioning data. The applications software may include one or more software modules, and may be executed in a suitable execution environment, such as an operating system environment, or the like.

Accordingly, it will be appreciated that the payment system 240 may be formed from any suitable processing system, such as any electronic processing device, including a microprocessor, microchip processor, logic gate configuration, firmware optionally associated with implementing logic such as an FPGA (Field Programmable Gate Array), or any other electronic device, system or arrangement. However, the POS device 210 may also be formed from a suitably programmed PC, Internet terminal, lap-top, or hand-held PC, a tablet, or smart phone, or the like. Thus, in one example, the processing system 210 is a standard processing system such as an Intel Architecture based processing system, which executes software applications stored on non-volatile (e.g., hard disk) storage, although this is not essential.

In other examples, such as described above, the payment system is formed of multiple computer systems interacting, for example, via a distributed network arrangement. As distributed networking is known in the art, it will not be described further in more detail.

In particular, the payment system may include or be in communication with a number of processing systems associated with each of an issuer, acquirer, card network and payment gateway, or alternatively, the payment system may be any one or more of these entities.

In one example as will be well understood in the art, the payment system sends the user account information and payment information to the merchant's acquirer. The acquirer then requests that the card network get an authorization from the user's issuing bank. The card network submits the transaction to the issuer for authorization and the issuing bank then authorizes the transaction if the account has sufficient funds to cover the amount payable. The issuer then routes payment to the acquirer who then deposits the payment into the merchant's account.

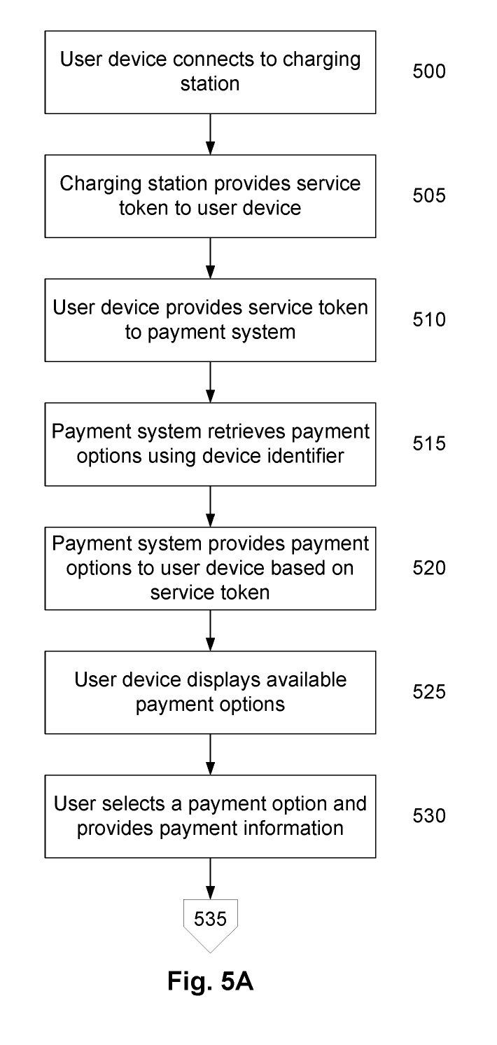

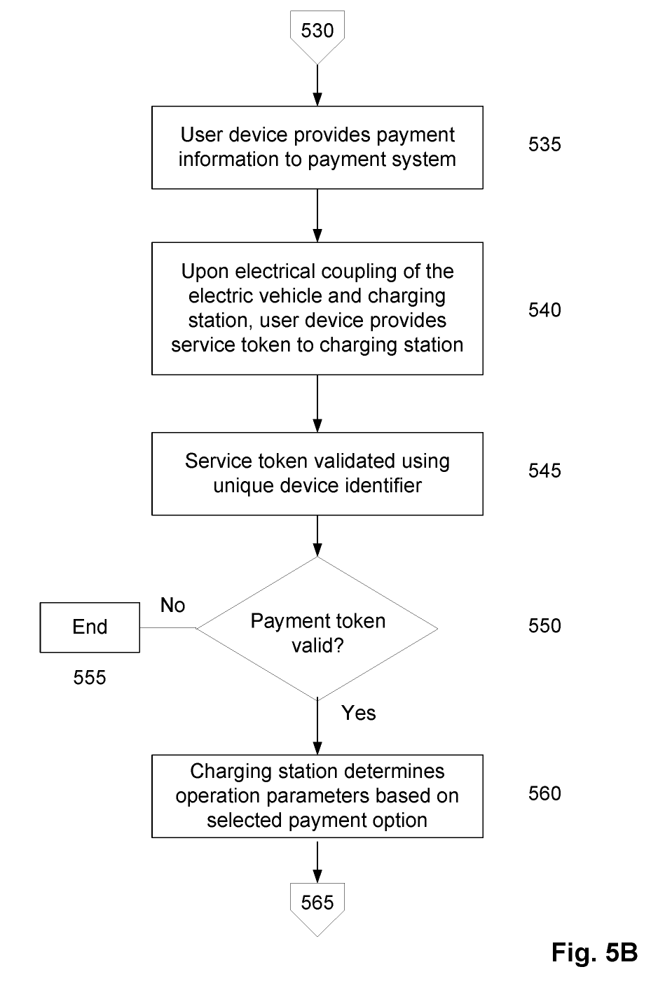

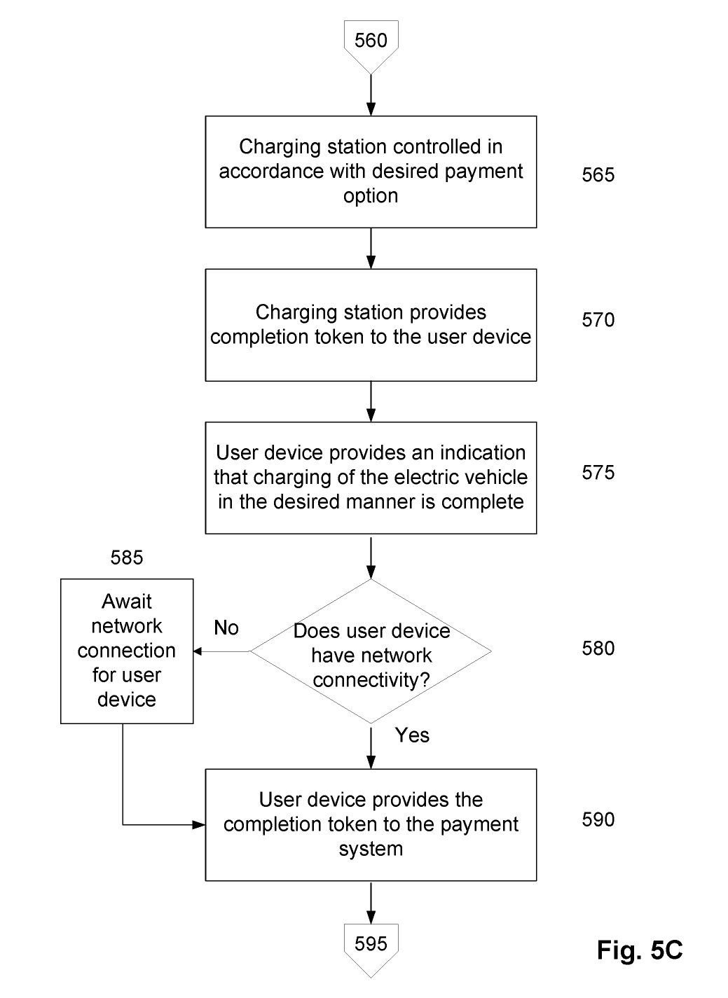

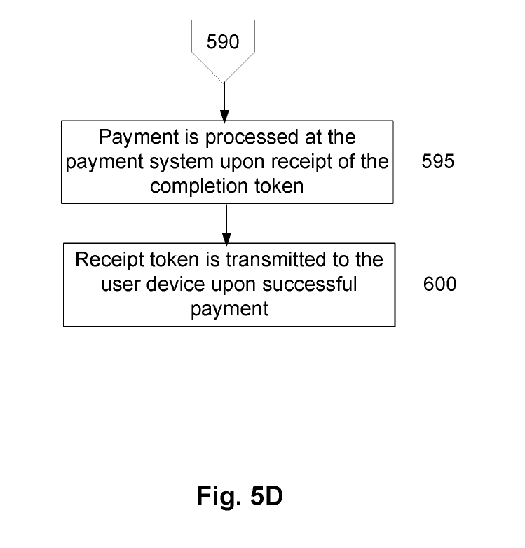

To illustrate further features of preferred practical implementations of the method, a further detailed example of a method of charging an electric vehicle will now be described with reference to FIGS. 5A-5C.

At step 500, a user connects or pairs their user device to a charging station, for example through Bluetooth connectivity, Zigbee, Wi-Fi or any other suitable wireless communications protocol. Once a connection has been established, the charging station provides a service token to the user device at step 505. The user device then provides the service token to a payment system at step 510. The user device may provide the service token to the payment system in accordance with instructions provided by the user through a user application executing on their user device or other suitable interface. In one example, the service token could be sent from the user device via a text message to the payment system.

At step 515, the payment system retrieves payment options (pre-selected by a merchant) from a data store using the service token which will typically be associated with a device identifier such as a unique device key. In this way, payment options applicable for a particular charging station can be linked appropriately using the service token and device identifier. At step 520, the payment system provides the payment options to the user device based on the service token. The available payment options are then displayed on a user interface of the user device including for example an interface provided by a user application at step 525. The available payment options can include, for example, providing power to the electric vehicle for a pre-determined amount of time, providing power of a pre-determined cost to the electric vehicle, providing a pre-determined amount of power to the electric vehicle and so forth. The payment option can also be, for example, one-off, for multiple instances, and so forth. The payment option for multiple instances can be for a pre-defined period of time, for example, a few weeks, a few months, a year, and so forth. Such payment options for multiple instances for a pre-defined period of time can be referred to as subscription options.

At step 530, the user selects a desired payment option and provides payment information. This may be done through a digital wallet or alternatively the user may enter their bank account or card details as would typically occur in a standard ecommerce transaction with a merchant. The payment information is provided by the user device to the payment system at step 535.

At step 540, upon electrically coupling the electric vehicle with the charging station, the user device then provides the service token to the charging station. The service token may then be validated at the charging station using the unique device identifier at step 545 to ensure that the correct charging station has received the payment token and that the payment option selected is valid for the particular charging station. The step of validating the service token using the device identifier may include a number of aspects. For instance, the payment token generated by the payment system may be encrypted using a key derived from the device identifier. In this case, part of the validation step would include decrypting the service token using the key derived from the device identifier. In this way, the device identifier may be used to determine that the service token has been received by the intended charging station, as well as to ensure the service token is from a legitimate source. A further validation step may include determining that the payment option selected by the user is valid for the particular charging station. The step of validating the service token may therefore ensure that the service token has not been inadvertently received by an incorrect charging station, and that an appropriate payment option has been selected.

At step 550, the charging station determines whether the service token is valid. If it is found to not be valid then the process ends at step 555. Otherwise, the process proceeds to step 560 where the charging station determines operation parameters based on the selected payment option. At step 565, the charging station is controlled in accordance with the desired payment option selected by the user.

At step 570, once the electric vehicle is charged in a manner as desired by the user, the charging station subsequently transmits a completion token to the user device. The completion token includes data on the payment quantum for the just-completed electric vehicle charging session. At step 575, once the user device receives the completion token, an indication is provided to the user that the charging of the electric vehicle has been carried out in the desired manner. The indication provided to the user can be, for example, a visual indication, an audible indication, a tactile indication, any combination of the aforementioned and so forth. The indication can provide the user with a signal to decouple the electric vehicle from the charging station.

At step 580, the user device provides the completion token to the payment system at step 590 if the user device has network connectivity. When the user device does not have network connectivity, the completion token is stored at the user device, and only provides the completion token to the payment system once the user device obtains network connectivity.

At step 595, once the payment system receives the completion token, payment is then processed in a similar way to which a standard ecommerce transaction is performed with a merchant. In response to successful payment using the provided completion token, the user device then receives a receipt token from the payment system at step 600. Once the receipt token is received, the user device then signals the user with regard to completion of payment.

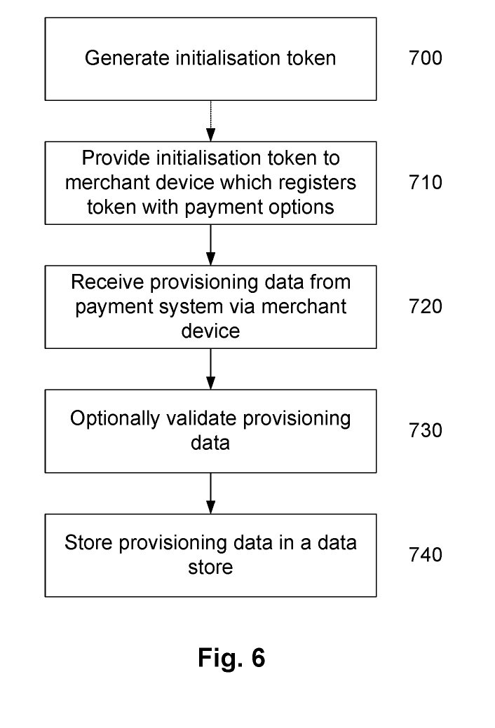

Now referring to FIG. 6, there is shown an example of a method of configuring a charging station that is controllable to selectively provide electrical power to charge an electric vehicle. The configuration or set-up is typically performed via communication with the merchant device and payment system.

At step 700, an initialisation token is generated for the charging station based on the unique device identifier assigned to the charging station. The initialisation token is typically stored on a local data store associated with the charging station along with the device identifier. This step may occur when the device is manufactured or at any stage before the merchant begins configuration of the device. The merchant then connects or pairs their merchant device to the charging station via any suitable form of wireless communication such as Bluetooth, Zigbee or Wi-Fi for example.

At step 710, the charging station provides the initialisation token to the merchant device which is responsive to register the token with payment options associated with providing electrical power to the electric vehicle. In one example, this may be performed through a merchant application executing on the merchant device or through any other suitable interface displayed on the merchant device. The merchant device then provides the registered initialisation token to a payment system, such as a payment server which is responsive to generate provisioning data for use in controlling the charging station and providing the provisioning data to the merchant device via a communications network (e.g. mobile network, Internet etc.).

At step 720, the charging station receives the provisioning data from the merchant device via Bluetooth (or Zigbee, Wi-Fi, Near Field Communication (NFC) etc.). The charging station then optionally validates the provisioning date at step 730 to ensure that the charging station is capable of executing the desired payment options and that the appropriate charging station has received the provisioning data. Finally, at step 740, the charging station stores the provisioning data in a data store, the provisioning data being used to at least partially control the charging station in accordance with the payment option selected by the user. In one example, the provisioning data is in the form of firmware that is permanently stored in read-only memory associated with the charging station. In accordance with the above described process, the charging station is now suitably programmed to execute any one of the available payment options pre-selected by the merchant for the particular charging station.

Accordingly, it will be appreciated that in at least one example, the above described methods and system may enable a payment convenience for the user seeking to charge an electric vehicle. As mentioned earlier, the user need not repeatedly select a payment option whenever the electric vehicle needs to be charged. In this regard, whenever the user device pairs with the charging station, and subsequent to electrical coupling between the electric vehicle and the charging station, the user need not initiate steps to select a payment option and ensure that payment is made to charge the electric vehicle, regardless of whether or not the user device has continuous network connectivity.

Furthermore, charging stations which can be used by a user with an appropriate user device can be readily distributed, basically to any location where there is access to a power source, and this is advantageous in creating infrastructure for electric vehicles without a need for substantial outlay by governments/state authorities. Consequently, improved infrastructure leads to more electric vehicles on the road and less pollution from fossil-fueled vehicles.

In addition, the charging stations also provide their owners/renters with an opportunity to generate a revenue stream from allowing third parties to use their charging stations, and this is also advantageous.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described.

1. A system for charging an electric vehicle, the system including one or more electronic processing devices configured to:
pair, to a user device, a charging station;
provide, to the user device, a service token, the service token being indicative of a selected payment option from one or more pre-selected payment options;
transmit, to the charging station, upon electrically coupling the electric vehicle to the charging station, the service token;
use, at the charging station, the service token to control the charging station to thereby provide an amount of power to the electric vehicle at least partially in accordance with the selected payment option;
provide, to the user device, a completion token after providing the power to the electric vehicle at least partially in accordance with the selected payment option;
provide, to a payment system, the completion token, the completion token including a payment quantum in accordance with the selected payment option; and
receive, from the payment system, a receipt token in response to successful payment.

2. The system according to claim 1, wherein providing the completion token to the payment system occurs whenever the user device is connected to a communications network.

3. The system according to claim 1, wherein the one or more pre-selected payment options are associated with at least one of:
a) providing power to the electric vehicle for a pre-determined amount of time;
b) providing power of a pre-determined cost to the electric vehicle;
c) providing a pre-determined amount of power to the electric vehicle; and
d) providing any of the above over a pre-determined duration of time.

4. The system according to claim 1, wherein the one or more electronic processing devices communicate via a wireless communications protocol.

5. The system according to claim 4, wherein the wireless communications protocol includes Bluetooth™ Low Energy (BLE) protocol.

6. The system according to claim 1, the one or more electronic processing devices being further configured to validate, at the charging station, the service token using a unique device identifier associated with the charging station.

7. The system according to claim 6, wherein validating the service token using the unique device identifier includes at least one of:
a) decrypting the service token using a key of the device identifier;
b) using the device identifier to determine that the service token has been received by an intended charging station; and,
c) determining that the payment option selected by the user is valid for the charging station.

8. The system according to claim 3, the one or more electronic processing devices being further configured to:
a) control a timer to determine an elapsed time since power was provided to the electric vehicle;
b) determine whether the elapsed time exceeds a pre-determined amount of time indicative of a purchased duration of electrical power supply to the electric vehicle; and,
c) in response to determining that the pre-determined amount of time has been exceeded, controlling the charging station to cut-off electrical power supply to the electric vehicle.

9. The system according to claim 3, the one or more electronic processing devices being further configured to:
a) monitor an electrical current drawn by the electric vehicle;
b) determine if a voltage level of a battery of the electric vehicle exceeds a predefined level; and,
c) control the charging station at least partially in accordance with the voltage level.

10. The system according to claim 1, the one or more electronic processing devices being further configured to communicate with a merchant device via a wireless communications protocol in order to pre-configure the charging station prior to use by the user.

11. The system according to claim 1, wherein the user device is integrated with the electric vehicle.

12. The system according to claim 1, the one or more electronic processing devices being further configured to select, at the user device, one of the one or more pre-selected payment options associated with charging the electric vehicle at the charging station.

13. A method for charging an electric vehicle, the method including, in one or more electronic processing devices:
pairing, to a user device, a charging station;
providing, to the user device, a service token, the service token being indicative of the selected payment option from one or more pre-selected payment options;
transmitting, to the charging station, the service token;
using, at the charging station, the service token to control the charging station to thereby provide an amount of power to the electric vehicle at least partially in accordance with the selected payment option;
providing, to the user device, a completion token after providing the power to the electric vehicle at least partially in accordance with the selected payment option;
providing, to a payment system, the completion token, the completion token including a payment quantum in accordance with the selected payment option; and
receiving, from the payment system, a receipt token in response to successful payment.

14. The method according to claim 13, the method further including, using the one or more electronic processing devices, selecting, at the user device, one of the one or more pre-selected payment options associated with charging the electric vehicle at the charging station.

15.-34. (canceled)
